(19) United States
(12) Patent Application Publication
(10) Pub. No.: US 2025/0347402 A1
(43) Pub. Date: Nov. 13, 2025

(54) TASK LIGHT

(71) Applicant: MILWAUKEE ELECTRIC TOOL CORPORATION, Brookfield, WI (US)

(72) Inventors: Andrew C. Wells, Milwaukee, WI (US); Daniel R. Janosch, New Berlin, WI (US); Victor G. Cinq-Mars, Milwaukee, WI (US); Martin S. Huertas, New Berlin, WI (US); Ashton L. Krepelka, Shorewood, WI (US)

(21) Appl. No.: 19/201,369

(22) Filed: May 7, 2025

Related U.S. Application Data
(60) Provisional application No. 63/643,531, filed on May 7, 2024.
(60) Provisional application No. 63/696,035, filed on Sep. 18, 2024.

(51) Int. Cl. F21V 21/30; F21L 4/02; F21V 21/08; F21V 21/40; F21V 23/02; F21V 23/06; F21Y 115/10

(52) U.S. Cl. CPC F21V 21/30; F21L 4/02; F21V 21/08; F21V 21/406; F21V 23/023; F21V 23/06; F21Y 2115/10

(57) ABSTRACT

A task light including a base module and a plurality of lighting elements. The base module includes a housing, a frame defining a plurality of handles, a user interface, and a battery receptacle, the battery receptacle configured to receive a battery. The plurality of lighting elements includes a first lighting element having a first end, a second end, a third end, and a fourth end, a second lighting element pivotally coupled to the second end of the first lighting element about a second pivot axis, and a third lighting element pivotally coupled to the fourth end of the first lighting element about a third pivot axis. The first end is pivotally coupled to the base module about a first pivot axis. The plurality of lighting elements is moveable between a working configuration and a storage configuration.

### CROSS-REFERENCE TO RELATED APPLICATIONS

The present application claims priority to U.S. Provisional Patent Application No. 63/696,035, filed Sep. 18, 2024, and U.S. Provisional Patent Application No. 63/643,531, filed May 7, 2024, the entire contents of which are incorporated herein by reference.

### FIELD OF THE DISCLOSURE

The present disclosure relates to task lights and, more particularly, to task lights for use with battery packs.

### BACKGROUND OF THE DISCLOSURE

Task lights can be used to illuminate work areas that are otherwise difficult to light. Examples of these areas include work sites, ceiling spaces, basement areas, and the like.

### SUMMARY OF THE DISCLOSURE

The disclosure provides, in one aspect, a task light including a base module including a housing, a frame defining a plurality of handles, a user interface, and a battery receptacle. The battery receptacle is configured to receive a battery. The task light further includes a plurality of lighting elements having a first lighting element including a first end, a second end, a third end, and a fourth end. The first end is pivotally coupled to the base module about a first pivot axis. The plurality of lighting elements also has a second lighting element pivotally coupled to the second end of the first lighting element about a second pivot axis and a third lighting element pivotally coupled to the fourth end of the first lighting element about a third pivot axis. The plurality of lighting elements is moveable between a working configuration and a storage configuration.

The disclosure provides, in another aspect, a task light including a base module including a housing, a frame having a latch, and a battery receptacle configured to receive a battery. The task light further includes a plurality of lighting elements having a first lighting element pivotally coupled to the base module about a first pivot axis, a second lighting element pivotally coupled to a first side of the first lighting element about a second pivot axis, and a third lighting element pivotally coupled to a second side of the first lighting element opposite from the second lighting element about a third pivot axis. The plurality of lighting elements is moveable between a working configuration and a storage configuration. In the storage configuration, the latch engages at least one lighting element of the plurality of lighting elements to inhibit movement about the first pivot axis.

The disclosure provides, in another aspect, a task light including a base module having a housing with a length, a height, and a width that extend perpendicular to one another and a battery receptacle configured to receive a battery. The task light further includes a plurality of lighting elements having a first lighting element pivotally coupled to the base module about a first pivot axis extending parallel to the width and being rotatable relative to the base module about a rotation axis extending perpendicular to the first pivot axis, a second lighting element pivotally coupled to a first side of the first lighting element about a second pivot axis, and a third lighting element pivotally coupled to a second side of the first lighting element opposite from the second lighting element about a third pivot axis.

Other features and aspects of the disclosure will become apparent by consideration of the following detailed description and accompanying drawings.

### BRIEF DESCRIPTION OF THE DRAWINGS

FIG. 1A is a front perspective view of a task light.

FIG. 1B is a rear perspective view of the task light of FIG. 1A.

FIG. 1C is a rear perspective view of the task light of FIG. 1A with a port cover removed.

FIG. 2A is a bottom perspective view of the task light of FIG. 1A.

FIG. 2B is a top plan view of the task light of FIG. 1A.

FIG. 3A is a front plan view of the task light of FIG. 1A.

FIG. 3B is a rear plan view of the task light of FIG. 1A.

FIG. 4 is an enlarged, perspective view of a latch of the task light of FIG. 1A.

FIG. 5 is a perspective view of the task light of FIG. 1A in a first working configuration.

FIG. 6 is a perspective view of the task light of FIG. 1A in a second working configuration.

FIG. 7 is a perspective view of the task light of FIG. 1A in a storage configuration.

FIG. 8 is a front plan view of a lighting module of the work light of FIG. 1A.

### DETAILED DESCRIPTION

Before any embodiments of the disclosure are explained in detail, it is to be understood that the disclosure is not limited in its application to the details of construction and the arrangement of components set forth in the following description or illustrated in the following drawings. The disclosure is capable of other embodiments and of being practiced or of being carried out in various ways. Also, it is to be understood that the phraseology and terminology used herein is for the purpose of description and should not be regarded as limiting.

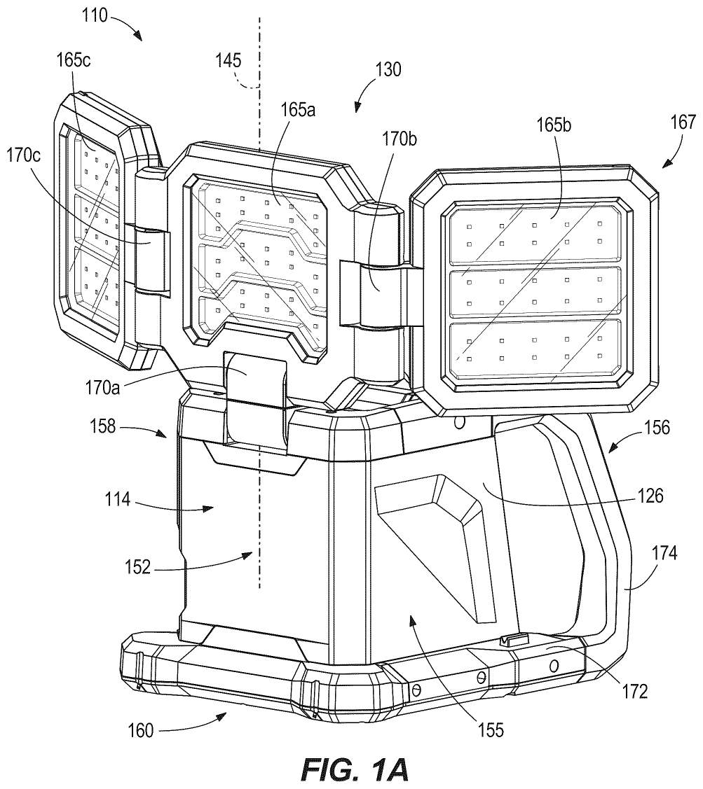

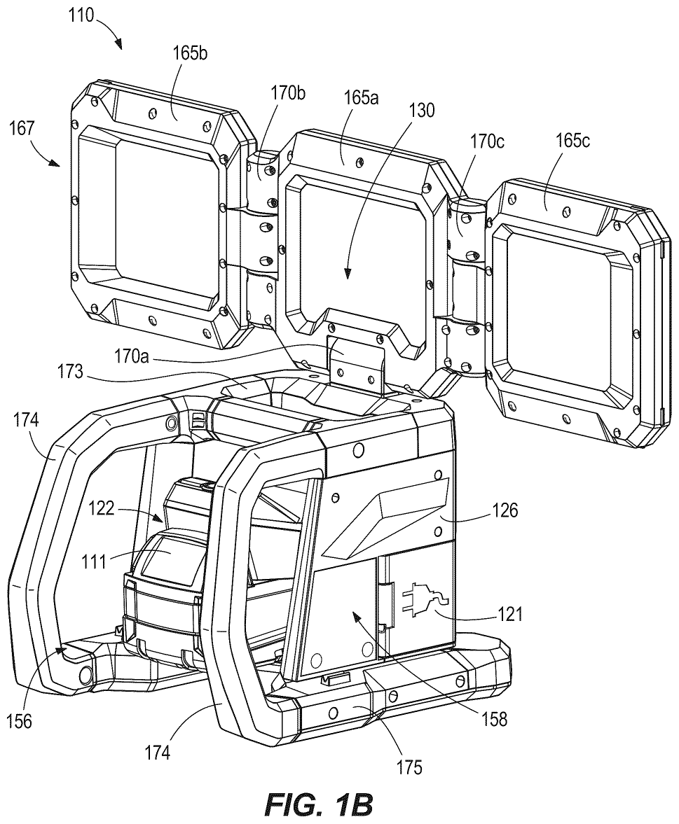

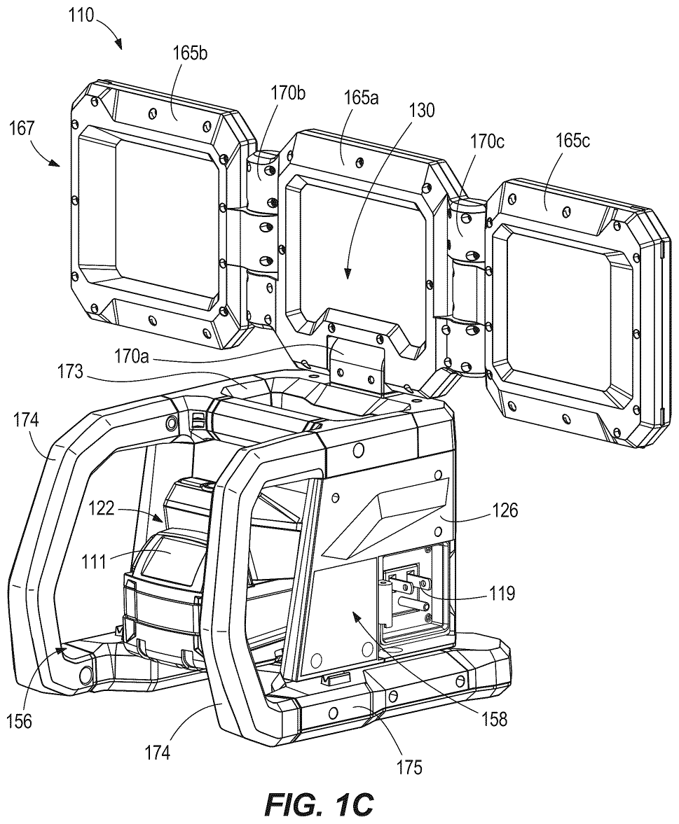

FIGS. 1A-8 illustrate a task light 110 according to an embodiment of the present disclosure. The illustrated task light 110 is configured for use with a battery 111. In some embodiments, the battery 111 may be a battery pack, such as Milwaukee Tool's M 18 battery pack. The task light 110 may also be referred to as an area light, a work light, a site light, or a stand light. The task light 110 is sized and shaped for easy transport. In particular, the task light 110 is relatively small such that the task light 110 can be carried to different locations by a single person and can fit in relatively small spaces. The task light 110 may be used to illuminate a worksite or other type of area surrounding the task light 110. The illustrated task light 110 includes a base module 114 supported on a surface (e.g., the ground, a floor, a tabletop, etc.) and a lighting module 167 having a plurality of lighting elements 165a-c, or light heads, coupled to the base module 114 via a first hinge 170a. The battery 111 is also removably coupled to the base module 114. The lighting module 167 includes one or more lighting components, such as LEDs, light bulbs, or the like, to provide light to an area.

In addition to the battery 111, the task light 110 may receive supplementary power, or be charged, via a plug 119 (FIG. 1C). The plug 119 may be disposed on a fourth side 158 of the base module 114. In the present embodiment, the plug 119 is a three prong AC power plug. The plug 119 is selectively covered with a port cover 121 (FIG. 1B) moveably connected to the base module 114. In the illustrated embodiment, the port cover 121 pivots and raises relative to the fourth side 158 of the base module 114, while remaining connected to the base module 114, to selectively uncover the plug 119. In other embodiments, other suitable covers may be used. The plug 119 may receive a voltage between approximately 90 Volts and 240 Volts. Additionally or alternatively, the plug 119 may be used as a power input plug to charge the battery 111 without the need for removing the battery 111 from the task light 110. In alternate embodiments, the task light 110 may include fewer or more ports. Alternatively or additionally, the plug 119 may be disposed on other portions of the task light 110. Some or all of the controls and indicators may instead be disposed on other portions of the task light 110 or may be omitted entirely.

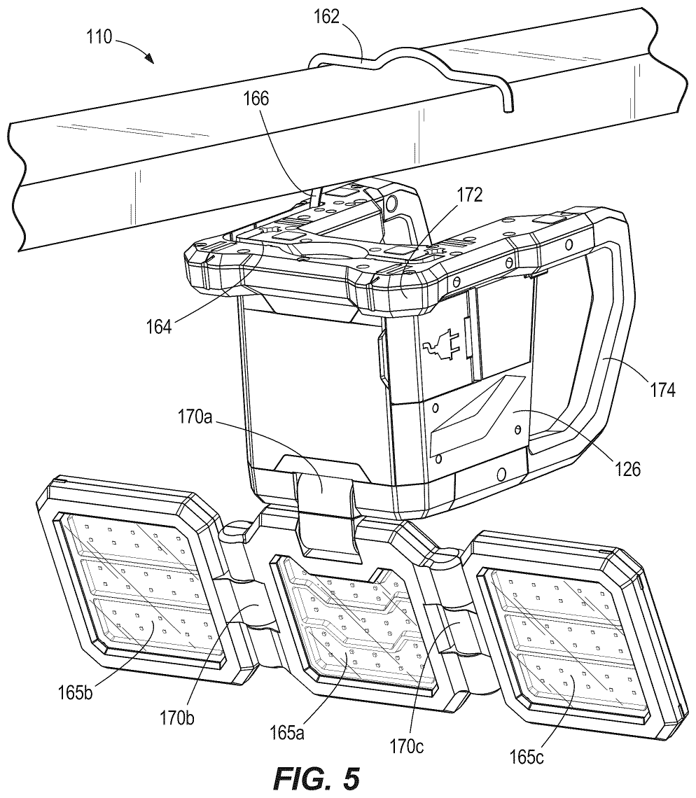

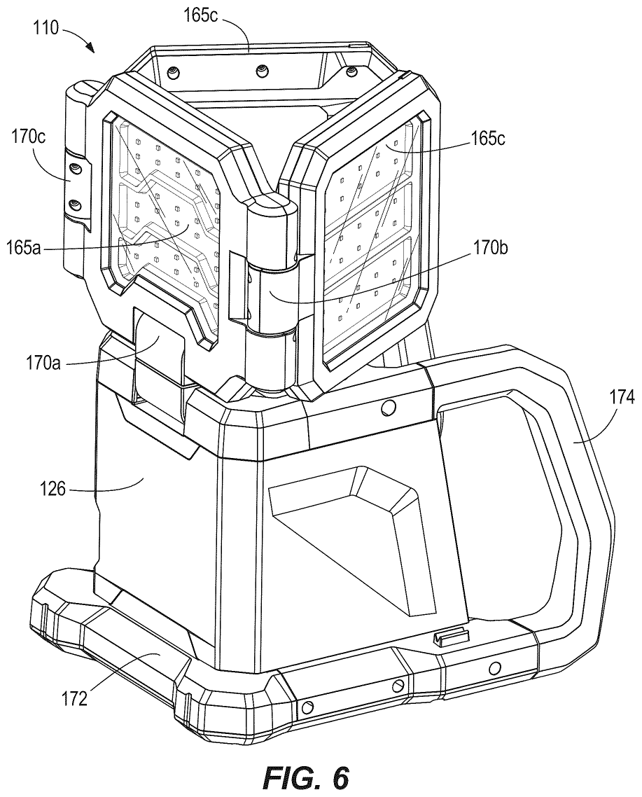

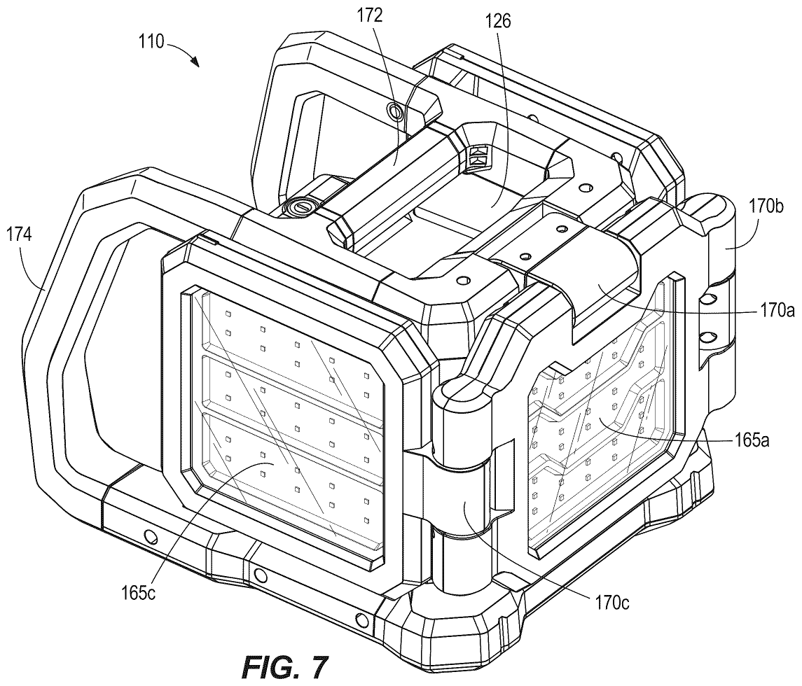

The lighting module 167 is movable relative to the base module 114 between a first, or working, configuration and a second, or storage, configuration. The storage configuration (FIG. 7) may also be referred to as a closed configuration or transport configuration. In the working configuration (FIGS. 5 and 6), the lighting module 167 extends from the base module 114 and provides illumination to an area around the task light 110. The working configuration may be one of a plurality of working configurations. That is, the lighting module 167 may be moved to several different positions relative to the base module 114 to provide illumination to the area around the task light 110.

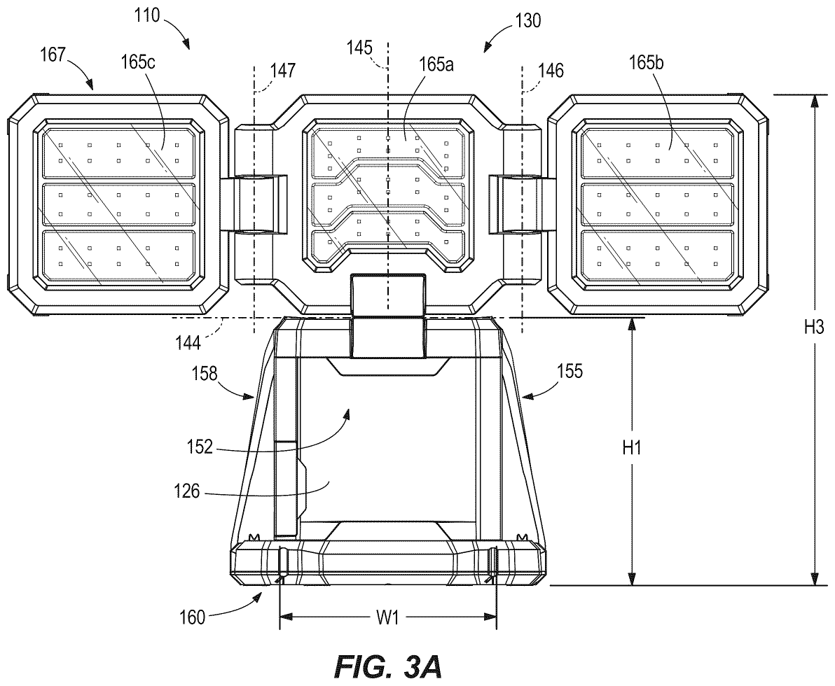

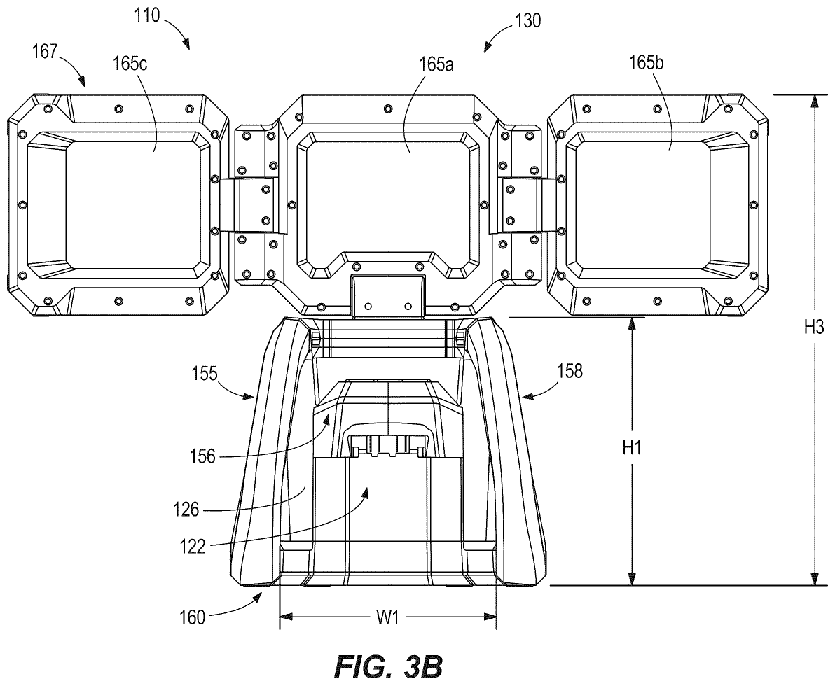

The base module 114 includes a housing 126 and a frame 172. In the illustrated embodiment, the base module 114 does not include any lighting elements. The housing 126 is approximately cube-like in shape. The housing 126 defines a first side 152, a second side 155, a third side 156, a fourth side 158, a bottom side 160, and a top side 130. The first side 152 may be understood as a front of the task light 110. The second side 155 and the fourth side 158 may be understood as left and right sides of the task light 110. The third side 156 may be understood as a back of the task light 110. In the illustrated embodiment, the third side 156 includes a battery receptacle 122 configured to receive the battery 111 (As best shown in FIG. 3B). In other embodiments, the battery receptacle 122 may be located elsewhere on the base module 114. When connected to the battery receptacle 122, the battery 111 provides power to the lighting elements 165a-c. The second side 155 and the fourth side 158 of the housing 126 extend past the battery receptacle 122 to at least partially overlap the battery receptacle 122 and the battery 111. As such, the second side 155 and the fourth side 158 help protect the battery receptacle 122 and the battery 111.

The frame 172 is substantially u-shaped and includes a top portion 173, a handle portion 174, and a bottom portion 175. The top portion 173 may be understood as a top of the base module 114, and the bottom portion 175 may be understood as a bottom of the task light 110. The frame 172 extends from the top side 130 of the housing 126 to the bottom side 160 of the housing 126. In other words, the top portion 173 of the frame 172 extends along and is in contact with the top side 130 of the housing 126, the bottom portion 175 of the frame 172 extends along and is in contact with the bottom side 160 of the housing 126. The handle portion 174 connects the top portion 173 and the bottom portion 175 adjacent to the third side 156 of the housing 126. The handle portion 174 is not, however, in contact with any part of the housing 126. The handle portion 174 defines a plurality of handles which may allow a user to carry or hold the task light 110. The handles extend rearwardly relative to the housing 126 on either side of the battery receptacle 122. In additions, the handles extend rearwardly (relative to the first side 152 or front of the housing 126) past the battery receptacle 122 and the battery 111. In the illustrated embodiment, the handle portion 174 defines two handles. Each of the handles is generally D-shaped. In other embodiments, the handle portion 174 may define fewer or more handles, and/or the handles may have other configurations. The handle portion 174 may be further configured to help protect a battery 111 connected to the battery receptacle 122. For example, the handles of the handle portion 174 are positioned on opposite sides of the battery receptacle 122 and the battery 111 such that the battery receptacle 122 and the battery 111 are located between the handles.

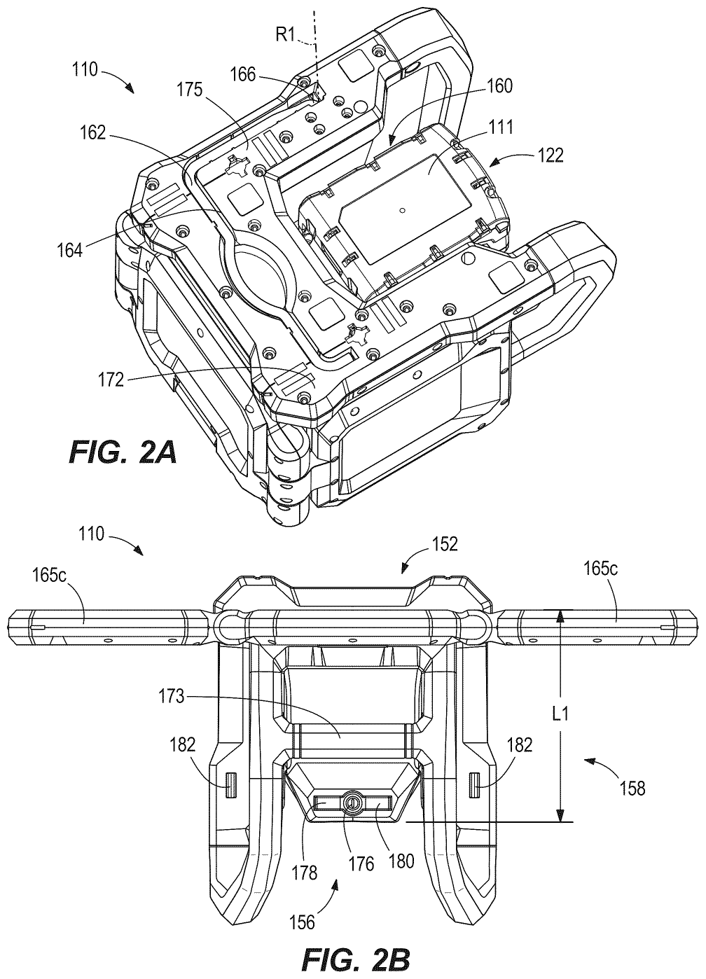

As shown in FIG. 2A, the bottom portion 175 is configured to be placed upon a surface, thereby supporting the task light 110. The bottom portion 175 further includes a rafter hook 162 movably disposed within a hook recess 164 formed within the frame 172. The rafter hook 162 is connected to the frame 172 via a hook hinge 166. The rafter hook 162 is generally u-shaped and is rotatable about a rafter hook axis R1. The rafter hook axis R1 extends in a direction generally parallel to the second side 155. The rafter hook 162 is movable via the hook hinge 166 about the axis R1 between a first or hook storage configuration (FIG. 2A), and a hook working configuration (FIG. 5). The hook storage configuration is defined by the rafter hook 162 being within the hook recess 164 such that the rafter hook 162 lays generally flat against the bottom side 160. The hook working configuration is defined by the rafter hook 162 extending from the base module 114 such that the rafter hook 162 is not in contact with the base module 114 of the task light 110. For example, the rafter hook 162 may extend generally perpendicularly from the second side 155. In the hook working configuration, the rafter hook 162 may be hung from a surface, thereby supporting the weight of the task light 110 such that the task light 110 may, for example, provide overhead illumination to an area. In some embodiments, the rafter hook 162 may be releasably secured in the hook storage configuration and the hook working configuration by a detent-type mechanism. Alternatively, the rafter hook 162 may be moved and held to any position between the hook storage configuration and the hook working configuration.

As shown in FIG. 2B, the top side 130 of the housing 126 includes a user interface for controlling operation of the lighting elements 165a-c. The illustrated user interface accessible from but recessed relative to the top side 130. The user interface may alternatively be located elsewhere on the task light 110. In the present embodiment, the user interface includes a power button 176, a mode button 178, and a brightness button 180. In other embodiments, the user interface may include fewer or more buttons or may include different types of actuators (e.g., slider switches, rotatable dials, etc.).

The power button 176 may turn the lighting elements 165a-c ON and OFF. The mode button 178 is operable to change an output mode of the lighting module 167 and may toggle which of the lighting elements 165a-c is ON (e.g., all lighting elements 165a-c on, a single lighting element 165a-c on, two of the lighting elements 165a-c on, etc.). The brightness button 180 may change an intensity of the lighting elements 165a-c. For example, the lighting elements 165a-c may be operable in a HIGH mode, a MEDIUM mode, and a LOW mode. In some embodiments, the lighting elements 165a-c may each produce light having a brightness of 1500 Lumens or more in the HIGH mode, a brightness of 1000 Lumens in MEDIUM mode, and a brightness of 500 Lumens or less in the LOW mode. For example, when all three lighting elements 165a-c are ON and in the HIGH mode, the lighting elements 165a-c may output a combined brightness of 4500 Lumens. The task light 110 is operable to switch modes by actuating the brightness button 180. M ore specifically, once a user has powered on the task light 110 by pressing the power button 176, the user may short press the mode button 178 to cycle between which of the lighting elements 165a-c is ON. The user may then short press the mode button 178 to cycle between the HIGH mode, MEDIUM mode, and LOW mode. In other embodiments, the lighting elements 165a-c may be operable in different modes and/or may be switchable between the modes by the power button 176. In other embodiments, the user interface may include other suitable actuators and/or displays.

As shown in FIGS. 2B-3B, the base module 114 has a length L1 measured from the first side 152 to the third side 156, a height H1 measured from the top side 130 to the bottom side 160, and a width W1 measured from the second side 155 to the fourth side 158. The length L1, width W1, and height H1 extend substantially perpendicular to one another. In the illustrated embodiment, the task light 110 may be sized and shaped for single user transport. In some embodiments, the length L1 of the base module 114 may be between about 3 inches and about 6 inches (between about 7.6 centimeters and about 15.2 centimeters). For example, the length L1 may be about 4.5 inches (about 11.4 centimeters). In some embodiments, the width W1 of the base module 114 may be between about 3 inches and about 6 inches (between about 7.6 centimeters and about 15.2 centimeters). For example, the width W1 may be about 5 inches (about 12.7 centimeters). In some embodiments, the height H1 of the base module 114 may be between about 3 inches and about 6 inches (between about 7.6 centimeters and about 15.2 centimeters). For example, the height H1 may be about 4.6 inches (about 11.7 centimeters).

The base module 114 and lighting module 167 define a total height H3 of the task light 110. In the illustrated embodiment, the total height H3 is approximately double the height H1 of the base module 114. In some embodiments, a total height H3 of the task light 110 may be about 11.7 inches (about 29.7 centimeters).

In the present embodiment, the task light 110 includes three lighting elements 165a-c: a first lighting element 165a, a second lighting element 165b, and a third lighting element 165c. In other embodiments, the task light 110 may include fewer or more lighting elements. Each lighting element 165a-c is approximately square in shape and includes a first end, a second end, a third end, and a fourth end, each end defining a side of the square shape of each lighting element 165a-c. The ends may also be referred to as sides or edges. The first lighting element 165a is pivotably and rotatably connected to the base module 114. In the illustrated embodiment, the first lighting element 165a is coupled to the base module 114 on the top side 130 opposite the rafter hook 162. The first end of the first lighting element 165a is coupled via the first hinge 170a to the base module 114. In other words, the first hinge 170a is coupled to the top side 130 of the base module 114 adjacent the first side 152. The first lighting element 165a is pivotable via the first hinge 170a relative to the base module 114 about a first pivot axis 144. The first pivot axis 144 extends in a direction parallel to the width W1 of the base module 114 (FIG. 3A). In the illustrated embodiment, the first lighting element 165a is pivotable up to about 270 degrees relative to the base module 114 about the first pivot axis 144. Movement of the first lighting element 165a is bounded by the first side 152 of the housing 126 and the top of the base module 114. In other embodiments, the first lighting element 165a may be pivotable by a greater or lesser amount relative to the base module 114.

The first lighting element 165a is also rotatable via the first hinge 170a relative to the base module 114 about a rotation axis 145. The rotation axis 145 extends perpendicular to the first pivot axis 144 (FIG. 3A). When the first lighting element 165a is upright (as shown in FIG. 3A), the rotation axis 145 also extends perpendicular to the width W1 of the base module 114 and parallel to the height H1 of the base module 114. In some embodiments, the first lighting element 165a may be rotatable up to 360 degrees relative to the base module 114 about the rotation axis 145. In other embodiments, the first lighting element 165a may be rotatable 180 degrees relative to the base module 114 about the rotation axis. In still other embodiments, the first lighting element 165a may be rotatable by a greater or lesser amount relative to the base module 114.

The second end of the first lighting element 165a is coupled via a second hinge 170b to the fourth end of the second lighting element 165b. Accordingly, the second lighting element 165b pivots about a second pivot axis 146. The second pivot axis 146 extends perpendicular to the first pivot axis 144. The second pivot axis 146 also extends parallel to the rotation axis 145. The second end of the third lighting element 165c is coupled via a third hinge 170c to the fourth end of the first lighting element 165a. Accordingly, the third lighting element 165c pivots about a third pivot axis 147. The third pivot axis 147 extends perpendicular the first pivot axis 144. The third pivot axis 147 also extends parallel to the rotation axis 145 and the second pivot axis 146. That is, the third lighting element 165c is coupled to a side of the first lighting element 165a opposite from the second lighting element 165b. As such, the lighting elements 165a-c are pivotally coupled to each other. In the illustrated embodiment, the second lighting element 165b can pivot about 270 degrees relative to the first lighting element 165a about the second hinge 170b, and the third lighting element 165c can pivot about 270 degrees relative to the first lighting element 165a about the third hinge 170c.

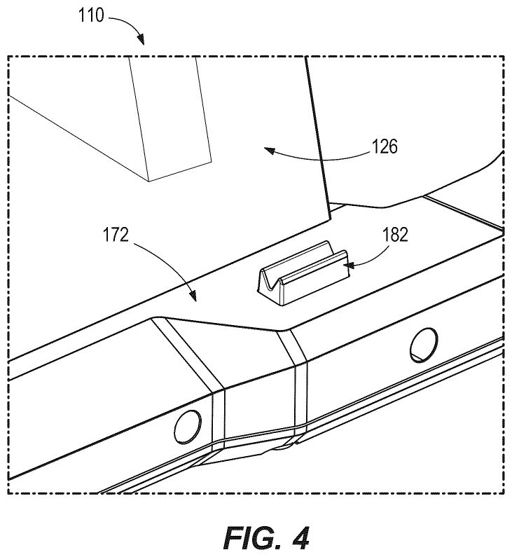

Referring to FIGS. 2B and 4, the frame 172 includes a latch 182 (e.g., a detent). In the illustrated embodiment, the frame 172 includes two latches 182, one positioned on each side of the housing 126. The latches 182 may be, for example, spring-loaded latches. The latches 182 are configured to hold the lighting elements 165a, 165b, 165c in the storage position (FIG. 7). For example, one latch 182 may engage the second lighting element 165b and one latch 182 may engage the third lighting element 165c to inhibit movement of the lighting elements 165a, 165b, 165c about the first hinge 170a. In other embodiments, the frame 172 may also or alternatively include a latch that engages the first lighting element 165a. In response to a user depressing or overcoming the latches 182, the lighting elements 165a, 165b, 165c may be permitted to be moved by the user to one of the working configurations. In response to the latches 182 not being depressed, the latches 182 resist movement of the lighting elements 165a, 165b, 165c about the first hinge 170a and hold the lighting elements 165a, 165b, 165c against the base module 114 in the storage configuration.

As illustrated in FIGS. 5-7, the lighting module 167 is pivotable relative to the base module 114 about the first pivot axis 144 between the working configurations (FIGS. 5 and 6) and the storage configuration (FIG. 7).

In the working configurations, the first lighting element 165a extends outwardly from the base module 114 and is not in contact with the base module 114. When in one of the working configurations, the first lighting element 165a is rotatable about the rotation axis 145 to change an orientation of the first lighting element 165a relative to the base module 114. For example, the first lighting element 165a may be rotated to emit light generally in a direction of the first side 152 of the base module 114, the second side 155 of the base module 114, the third side 156 of the base module 114, or any position in between. Rotation about the rotation axis 145 also allows the first lighting element 165a to face toward or away from the base module 114 when in one of the stowed positions. The second lighting element 165b may be rotated about the second hinge 170b and the third lighting element 165c may be rotated about the third hinge 170c to emit light outwardly from the base module 114.

In a first working configuration, the lighting elements 165a-c create a substantially trapezoidal shape. In this configuration, the lighting elements 165a-c emit light generally in a forward direction relative to the task light 110. In the present embodiment, the task light 110 may be positioned in a second working configuration (FIG. 6). In this configuration, the lighting elements 165a-c create a substantially triangular shape. In this configuration, the lighting elements 165a-c emit light generally in all directions or in a 360-degree pattern around the task light 110. The lighting elements 165a-c may also be positioned in other working configurations between the first working configuration (FIG. 5) and the second working configuration (FIG. 6). For example, in a third working configuration, the lighting elements may be arranged in a straight line (FIG. 3A). In this configuration, the lighting elements 165a-c emit light in a forward direction relative to the task light 110. In a fourth working configuration, the lighting elements 165a-c may be arranged in a substantially trapezoidal shape facing inwardly. In this configuration, the lighting elements 165a-c emit light generally in a rearward direction relative to the task light 110. In any of the working configurations, the rafter hook 162 may be moved to the hook working configuration such that the rafter hook 162 may be hung from a surface to provide overhead illumination to an area (FIG. 5).

In the storage configuration, the first lighting element 165a is in contact with the base module 114. A pivoting range of the first lighting element 165a may, therefore, be limited by the base module 114. For example, the first lighting element 165a may pivot about the first pivot axis 144 until the first lighting element 165a contacts with the base module 114. In such embodiments, the first lighting element 165a may pivot about 270 degrees. In other embodiments, the pivoting range of the first lighting element 165a may be limited by the first hinge 170a to a smaller range (e.g., 180 degrees, 90 degrees, etc.). In the storage configuration of the illustrated embodiment (as shown in FIG. 7), the first lighting element 165a is adjacent or in contact with the first side 152 of the base module 114 and faces away from the base module 114, the second lighting element 165b is adjacent or in contact with the second side 155, and the third lighting element 165c is adjacent or in contact with the fourth side 158. In other words, the first lighting element 165a extends along or adjacent the top side 130, the second lighting element 165b extends along or adjacent the second side 155, and the third lighting element 165c extends along or adjacent the fourth side 158. Accordingly, when in the storage configuration, the lighting elements 165a-c wrap around the outside or perimeter of the base module 114. In the storage configuration, the lighting module 167 is oriented toward the base module 114 to protect the lighting elements 165a-c. Alternately, the lighting module 167 may be oriented outward from the base module 114 such that the task light 110 may be usable in both the working configuration and the storage configuration.

To reach the first working configuration from the storage configuration, the latch 182 is depressed and the first lighting element 165a is rotated 90 degrees relative to the top side 130, the second lighting element 165b is rotated 45 degrees relative to the first lighting element 165a, and the third lighting element 165c is rotated 45 degrees relative to the first lighting element 165a (FIG. 5). To reach the second working configuration from the storage configuration, the latch 182 is depressed and the first lighting element 165a is rotated 90 degrees relative to the top side 130, the second lighting element 165b is rotated-45 degrees relative to the first lighting element 165a, and the third lighting element 165c is rotated-45 degrees relative to the first lighting element 165a. To reach the third working configuration from the storage configuration, the latch 182 is depressed and the first lighting element 165a is rotated 90 degrees relative to the top side 130, the second lighting element 165b is rotated 90 degrees relative to the first lighting element 165a, and the third lighting element 165c is rotated 90 degrees relative to the first lighting element 165a (FIG. 3A). To reach the fourth working configuration from the storage configuration, the latch 182 is depressed and the first lighting element 165a is rotated 90 degrees about the first pivot axis 144 relative to the top side 130 and 180 degrees about the rotation axis 145, the second lighting element 165b is rotated 45 degrees relative to the first lighting element 165a, and the third lighting element 165c is rotated 45 degrees relative to the first lighting element 165a.

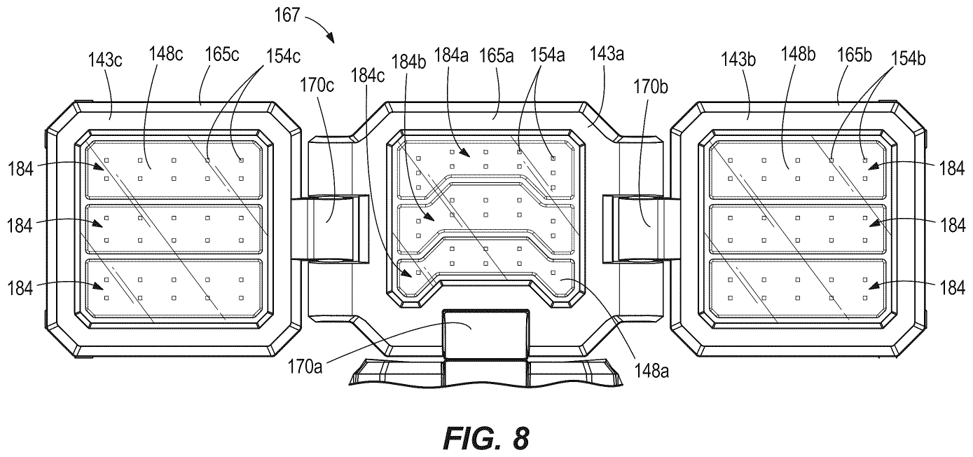

Referring to FIG. 8, each lighting element 165a-c includes a housing 143a-c, a light panel 148a-c, and a plurality of light emitting diodes (LEDs) 154a-c supported on the light panel 148a-c. The housing 143a-c at least partially surrounds the lighting element 165a-c to support and protect the lighting element 165a-c. The housing 143a-c may be made of an insulative or conductive plastic. The lighting element 165a-c is a relatively thin, planar member or plate. The lighting element 165a-c may be made of metal, such as aluminum. The lighting element 165a-c may be any size. In the illustrated embodiment, the first lighting element 165a extends along a majority of the width W1 of the base module 114 of the task light 110. Additionally, the first lighting element 165a is positioned to be in direct contact with the base module. The base module may, therefore, help dissipate heat produced by the lighting element 165a-c.

Each lighting element 165a-c may include a plurality of rows 184 of LEDs 154a-c. In the present embodiment, each lighting element 165a-c includes three (3) rows 184 of LEDs 154a-c. In other embodiments, the lighting elements 165a-c may include fewer or more rows 184. Each of the plurality of rows 184 of the second lighting element 165b and the third lighting element 165c includes ten (10) LEDs 154b, 154c. In contrast, a first row 184a of the first lighting element 165a includes twelve (12) LEDs 154a, a second row 184b of the first lighting element 165a includes ten (10) LEDs 154a, and a third row 184c of the first lighting element 165a includes eight (8) LEDs 154a. Accordingly, each lighting element 165a-c includes thirty (30) total LEDs 154a-c. In other embodiments, the lighting elements 165a-c may include fewer or more LEDs 154a-c (e.g., 15 LEDs, 18 LEDs, 25 LEDs, 35 LEDs, etc.).

Although the disclosure has been described in detail with reference to certain preferred embodiments, variations and modifications exist within the scope and spirit of one or more independent aspects of the disclosure as described.

Various features of the disclosure are set forth in the following claims.

What is claimed is:

1. A task light comprising:
a base module including a housing, a frame defining a plurality of handles, a user interface, and a battery receptacle, the battery receptacle configured to receive a battery; and
a plurality of lighting elements including:
a first lighting element including a first end, a second end, a third end, and a fourth end, the first end pivotally coupled to the base module about a first pivot axis,
a second lighting element pivotally coupled to the second end of the first lighting element about a second pivot axis, and
a third lighting element pivotally coupled to the fourth end of the first lighting element about a third pivot axis,
wherein the plurality of lighting elements is moveable between a working configuration and a storage configuration.

2. The task light of claim 1, wherein the first lighting element includes a housing, a light panel positioned within the housing and configured to be operated by the user interface, and a plurality of light emitting diodes (LEDs) supported on the light panel.

3. The task light of claim 1, wherein the housing defines a first side of the task light, a second side of the task light, a third side of the task light, and a fourth side of the task light.

4. The task light of claim 3, wherein in the storage configuration, the first lighting element extends adjacent the first side, the second lighting element extends adjacent the second side, and the third lighting element extends adjacent the fourth side.

5. The task light of claim 1, wherein the frame includes a rafter hook movably disposed within a hook recess formed within the frame.

6. The task light of claim 1, wherein in the working configuration, the plurality of lighting elements creates a substantially trapezoidal shape.

7. The task light of claim 6, wherein the working configuration is a first working configuration, and wherein the plurality of lighting elements is moveable to a second working configuration.

8. The task light of claim 7, wherein in the second working configuration, the plurality of lighting elements creates a substantially triangular shape.

9. A task light comprising:
a base module including a housing, a frame having a latch, and a battery receptacle configured to receive a battery; and
a plurality of lighting elements including:
a first lighting element pivotally coupled to the base module about a first pivot axis,
a second lighting element pivotally coupled to a first side of the first lighting element about a second pivot axis, and
a third lighting element pivotally coupled to a second side of the first lighting element opposite from the second lighting element about a third pivot axis,
wherein the plurality of lighting elements is moveable between a working configuration and a storage configuration, and
wherein in the storage configuration, the latch engages at least one lighting element of the plurality of lighting elements to inhibit movement about the first pivot axis.

10. The task light of claim 9, wherein the latch is configured to be depressed to permit movement of the plurality of lighting elements from the storage configuration to the working configuration.

11. The task light of claim 9, wherein the latch is a first latch configured to engage the second lighting element in the storage configuration, and wherein the frame has a second latch configured to engage the third lighting element in the storage configuration.

12. The task light of claim 11, wherein the first latch and the second latch are spring-loaded latches.

13. The task light of claim 11, wherein in the storage configuration, the plurality of lighting elements wraps around a perimeter of the base module.

14. A task light comprising:
a base module including a housing having a length, a height, and a width that extend perpendicular to one another and a battery receptacle configured to receive a battery; and
a plurality of lighting elements including:
a first lighting element pivotally coupled to the base module about a first pivot axis extending parallel to the width and being rotatable relative to the base module about a rotation axis extending perpendicular to the first pivot axis,
a second lighting element pivotally coupled to a first side of the first lighting element about a second pivot axis, and
a third lighting element pivotally coupled to a second side of the first lighting element opposite from the second lighting element about a third pivot axis.

15. The task light of claim 14, wherein the second pivot axis and the third pivot axis extend perpendicular to the first pivot axis.

16. The task light of claim 14, wherein the second pivot axis and the third pivot axis extend parallel to the rotation axis.

17. The task light of claim 14, wherein a first hinge is configured to pivotally couple the plurality of lighting elements to the base module.

18. The task light of claim 17, wherein the first lighting element is pivotally coupled to the base module by the first hinge.

19. The task light of claim 17, wherein the second lighting element is pivotally coupled to the first lighting element by a second hinge and the third lighting element is pivotally coupled to the first lighting element by a third hinge.

20. The task light of claim 14, wherein the first lighting element is pivotable up to about 270 degrees relative to the base module about the first pivot axis, and wherein the first lighting element is rotatable up to about 360 degrees relative to the base module about the rotation axis.
